(19) United States
(12) Patent Application Publication
(10) Pub. No.: US 2022/0337392 A1
(43) Pub. Date: Oct. 20, 2022

(54) AUTOMATIC DIGITAL MEDIA AUTHENTICATOR

(71) Applicant: Daniel Christopher Schauer, Tacoma, WA (US)

(72) Inventor: Daniel Christopher Schauer, Tacoma, WA (US)

(21) Appl. No.: 17/343,940

(22) Filed: Jun. 10, 2021

Related U.S. Application Data
(60) Provisional application No. 63/176,254, filed on Apr. 17, 2021.
(60) Provisional application No. 63/178,535, filed on Apr. 23, 2021.
(60) Provisional application No. 63/184,813, filed on May 6, 2021.

(51) Int. Cl. H04L 9/06; H04L 9/00; H04L 9/32

(52) U.S. Cl. CPC H04L 9/0618; H04L 9/008; H04L 9/3247; H04L 9/0643; H04L 2209/38

(57) ABSTRACT

Systems and methods for authentication of a digital asset using a digital Non-Fungible Token (NFT) generated by a digital asset authenticator are disclosed. The digital asset authenticator provides an encoding algorithm supporting segmentation of the digital asset into discrete chunks. The discrete chunks of the digital asset are converted to base64 strings of predefined length. Each chunk is assigned a distinct non-fungible token (NFT) before or at the same time as the digital asset chunks are re-streamed to be broadcasted on streaming platforms and/or social platforms.

### CROSS REFERENCE TO RELATED APPLICATIONS/PRIORITY

The present invention claims priority to U.S. Provisional Patent Application No. 63/176,254 filed Apr. 17, 2021, 63/178,535 filed Apr. 23, 2021, and 63/184,813 filed May 6, 2021, all of which are incorporated by reference into the present disclosure as if fully restated herein. Any conflict between the incorporated material and the specific teachings of this disclosure shall be resolved in favor of the latter. Likewise, any conflict between an art-understood definition of a word or phrase and a definition of the word or phrase as specifically taught in this disclosure shall be resolved in favor of the latter.

### TECHNICAL FIELD

The present disclosure relates, generally, to authenticating digital asset (or content). More particularly, the present disclosure relates to using a non-fungible token for authenticating and claiming ownership of the digital asset.

### BACKGROUND

Currently, unauthorized digital content such as pirated digital content or partial deep fakes of the digital content can be created with the help of artificial intelligence (AI) and machine learning models. The partial deep fake or deep fakes are synthetic media (image or video) created to deceive viewers. For example, a deep fake is a synthetic media in which a person in the synthetic media is replaced with someone else, or the person, in the synthetic media, is shown to say something that was not, in fact, said by the person using a technique sometimes called Face Swapping. Thus, the unauthorized digital content has the potential to undermine the trust of the public in all reported and purportedly factual news and media.

Therefore, there is a need for detecting the unauthorized digital content or the partial deep fakes and warn viewers as well as platforms showing the unauthorized content. The potential to make content that “looks just the normal show” where deep fake technology is maliciously employed could be disastrous to the true brand's reputation.

### SUMMARY

Wherefore, it is an object of the present invention to overcome the above-mentioned shortcomings and drawbacks associated with the current technology.

The presently disclosed invention relates to automatic digital asset authenticator systems comprising a processor coupled to a system bus, a memory coupled to the system bus, the memory being a non-transitory machine-readable storage medium configured to store instructions for execution by the processor, a communication interface coupled to the system bus, and an automatic digital asset authenticator stored in the memory, wherein the automatic digital asset authenticator is configured to cause the processor to automatically generate a non-fungible token (NFT) for a digital asset. According to a further embodiment, the system further comprises According to a further embodiment, the system further comprises a digital wallet stored in the memory. According to a further embodiment, the automatic digital asset authenticator includes an encoder, an encryptor, and an NFT generator. According to a further embodiment, the automatic digital asset authenticator is configured to cause the processor to automatically divide a digital asset into a plurality of chunks and generate a separate, distinct NFT for each chunk. According to a further embodiment, a length each chunk is between 0.10 seconds and 3 seconds length of video or audio time for video or audio digital assets. According to a further embodiment, the encoder is configured to cause the processor to encode each chunk of the digital asset base64 strings. According to a further embodiment, the NFT generator is configured to cause the processor to implement a secure hash algorithm to generate a unique signature for each chunk in real time as the digital asset is being inputted into the system. According to a further embodiment, the encryptor is configured to cause the processor to encrypt the encoded digital asset. According to a further embodiment, the encryptor includes a key generator and is configured to cause the processor to generate a private encryption key and a public encryption key using a hash of a seed phrase, wherein the seed phrase comprises a collection of characters in a language of the key generator. According to a further embodiment, the automatic digital asset authenticator is configured to cause the processor to automatically generate a custom smart contract defining terms of creating the NFT and deploying the smart contract to a blockchain. According to a further embodiment, the automatic digital asset authenticator is configured to cause the processor to store the private encryption key, the public encryption key, and NFT in the memory. According to a further embodiment, the automatic digital asset authenticator is configured to cause the processor to sequentially create a first NFT for a first chunk of a digital asset, increment a nonce, and then continue creating additional NFTs for each additional chunk of the digital asset until an end of the digital asset is reached. According to a further embodiment, the encryption is a homomorphic encryption.

The presently disclosed invention further relates to methods for automatically authenticating digital assets using an automatic digital asset authenticator system including a processor coupled to a system bus, a memory coupled to the system bus, the memory being a non-transitory machine-readable storage medium configured to store instructions for execution by the processor, a communication interface coupled to the system bus, and an automatic digital asset authenticator stored in the memory, the method comprising loading a portion of a digital asset into the memory and the automatic digital asset authenticator being configured to cause the processor to automatically generate a non-fungible token (NFT) for the portion of the digital asset. According to a further embodiment, the method further comprises storing the NFT in a digital wallet stored in the memory. According to a further embodiment, the automatic digital asset authenticator includes an encoder, an encryptor, and an NFT generator. According to a further embodiment, the method further comprises automatically dividing a digital asset into a plurality of chunks and generating a separate, distinct NFT for each chunk, with each chunk being between 0.10 seconds and 3 seconds length of video or audio time for video or audio digital assets. According to a further embodiment, the method further comprises encoding each chunk into base64 strings, and implementing a secure hash algorithm to generate a unique signature for each chunk in real time as the digital asset is being loaded into the system. According to a further embodiment, the method further comprises encrypting the encoded digital asset, generating a private encryption key and a public encryption key using a hash of a seed phrase, wherein the seed phrase comprises a collection of characters in a language of the key generator, and storing the private encryption key, the public encryption key, and NFT in the memory. According to a further embodiment, the method further comprises generating a custom smart contract defining terms of creating the NFT and deploying the smart contract to a blockchain.

Embodiments of the disclosed invention are related to an automatic digital asset authenticator encoding algorithm supporting segmentation of the digital asset such as audio and video into discrete chunks and further supporting the conversion of the discrete chunks of the digital asset to base64 strings, where length of the discrete chunks may be predefined. In some embodiments, the length of the discrete chunks being preferably between 0.010 seconds and 30 seconds.

Embodiments of the disclosed invention are related to an encoding algorithm stored in non-transient memory that when executed by a processor causes a real-time segmentation of a digital asset into predetermined lengths of chunks, where each chunk is assigned a distinct non-fungible token (NFT) before or at the same time as the digital asset chunks are re-streamed to be broadcasted on streaming platforms and/or social platforms.

Embodiments of the disclosed invention are related to an NFT minting algorithm stored in non-transient memory that when executed by a processor cause real-time generation of single NFT tokens for preferably any base64 string.

Embodiments of the disclosed invention are related to a digital wallet that stores the base64 string for the digital asset and the minted NFT for the digital asset. Embodiments of the disclosed invention preferably support digital asset associated with multiple publishers/creators for a shared brand or enterprise. The digital asset may comprise metadata, where the metadata may comprise, information relating to IP addresses, computers, and login credential of a user that is uploading the digital asset and generating the NFT. Further, the disclosed invention preferably supports very low cost or free generation of NFTs.

Embodiments of the disclosed invention are related to an encryption algorithm supporting—long private keys. For example, the long private keys may comprise keys such as 1024-bit Rivest-Shamir-Adleman (RSA) keys, 2048-bit RSA keys, 3072-bit RSA keys, and 15360-bit RSA keys, 80-bit symmetric keys, 112-bit symmetric keys, 128-bit symmetric keys, and 256-bit symmetric keys.

Embodiments of the disclosed invention are related to a consensus mechanism. The consensus mechanism includes protocols and/or algorithms that allow distributed/networked systems of computers (such as a blockchain) to work together and stay secure. Further, the consensus mechanism helps prevent certain kinds of economic attacks such as “51% attack”. In the 51% attack, an attacker can compromise consensus by controlling 51% of the network. The consensus mechanism is designed to make the 51% attack unfeasible

Various objects, features, aspects, and advantages of the present invention will become more apparent from the following detailed description of preferred embodiments of the invention, along with the accompanying drawings in which like numerals represent like components. The present invention may address one or more of the problems and deficiencies of the current technology discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. It is to be appreciated that the accompanying drawings are not necessarily to scale since the emphasis is instead placed on illustrating the principles of the invention. The invention will now be described, by way of example, with reference to the accompanying drawings in which:

FIG. 1A illustrates a block diagram of an automatic digital authenticator, in accordance with an embodiment of the disclosure;

FIG. 1B illustrates a block diagram of a system configured to authenticate the digital asset, in accordance with an embodiment of the disclosure;

FIG. 2 is a schematic diagram illustrating different types of NFTs, in accordance with an embodiment of the disclosure;

FIG. 3 is a schematic diagram illustrating contents of: an authentic digital asset, streaming media token, a streaming media chunk associated with the streaming media token, an uploaded asset, a simple derivative token associated with the authentic digital asset, an asset distribution token, and a simple derivative token associated with the asset distribution token, in accordance with an embodiment of the disclosure;

FIG. 4 illustrates a graphical user interface (GUI) with an NFT generated for a media asset, in accordance with an embodiment of the disclosure;

FIG. 5 illustrates a workflow of generation of NFT by the automatic digital asset authenticator at a high level, in accordance with an embodiment of the disclosure;

FIG. 6 illustrates a workflow of collecting and requesting new NFT requests in queue, in accordance with an embodiment of the disclosure;

FIG. 7 illustrates a high-level block diagram for generating encryption keys, in accordance with an embodiment of the disclosure;

FIG. 8 illustrates a detailed workflow for the generation of encryption keys and storage of the encryption keys, in accordance with an embodiment of the disclosure;

FIG. 9 illustrates a workflow for better seed generation, in accordance with an embodiment of the disclosure;

FIG. 10 illustrates a workflow for claiming authorship of the digital asset, in accordance with an embodiment of the disclosure;

FIG. 11A illustrates a workflow for claiming authorship of a digital asset by a first user, in accordance with an embodiment of the disclosure;

FIG. 11B illustrates a workflow for claiming authorship of the digital asset by a second user, in accordance with an embodiment of the disclosure; and

FIG. 11C illustrates a workflow for validating claimed authorship of the digital asset, in accordance with an embodiment of the disclosure

### DETAILED DESCRIPTION

The present invention will be understood by reference to the following detailed description, which should be read in conjunction with the appended drawings. It is to be appreciated that the following detailed description of various embodiments is by way of example only and is not meant to limit, in any way, the scope of the present invention. In the summary above, in the following detailed description, in the claims below, and in the accompanying drawings, reference is made to particular features (including method steps) of the present invention. It is to be understood that the disclosure of the invention in this specification includes all possible combinations of such particular features, not just those explicitly described. For example, where a particular feature is disclosed in the context of a particular aspect or embodiment of the invention or a particular claim, that feature can also be used, to the extent possible, in combination with and/or in the context of other particular aspects and embodiments of the invention, and in the invention generally. The terms “comprise(s),” “include(s),” “having,” “has,” “can,” “contain(s),” and grammatical equivalents and variants thereof, as used herein, are intended to be open-ended transitional phrases, terms, or words that do not preclude the possibility of additional acts or structures. are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components. The singular forms “a,” “and” and “the” include plural references unless the context clearly dictates otherwise. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40% means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

The embodiments set forth the below represent the necessary information to enable those skilled in the art to practice the invention and illustrate the best mode of practicing the invention. For the measurements listed, embodiments including measurements plus or minus the measurement times 5%, 10%, 20%, 50% and 75% are also contemplated. For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

In addition, the invention does not require that all the advantageous features and all the advantages of any of the embodiments need to be incorporated into every embodiment of the invention.

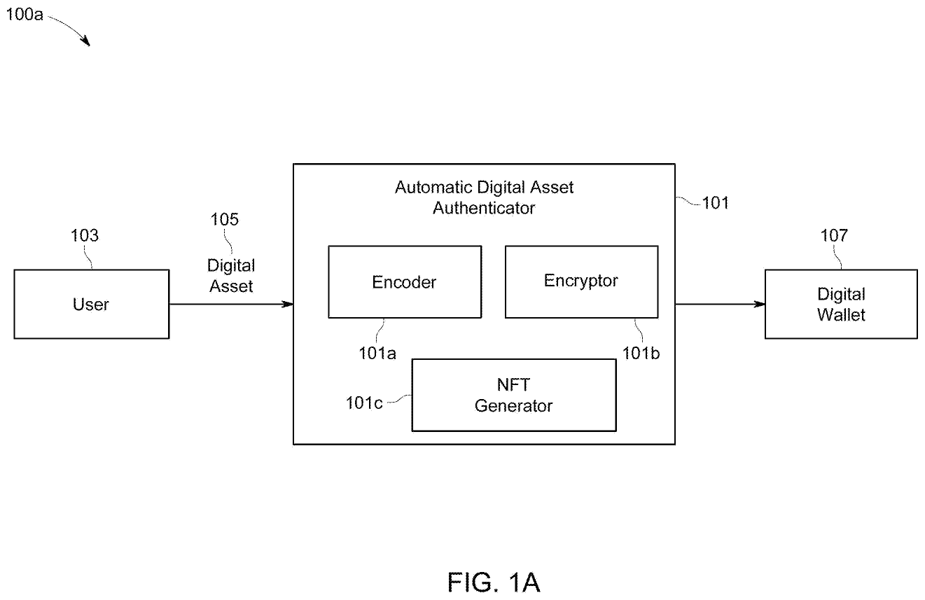

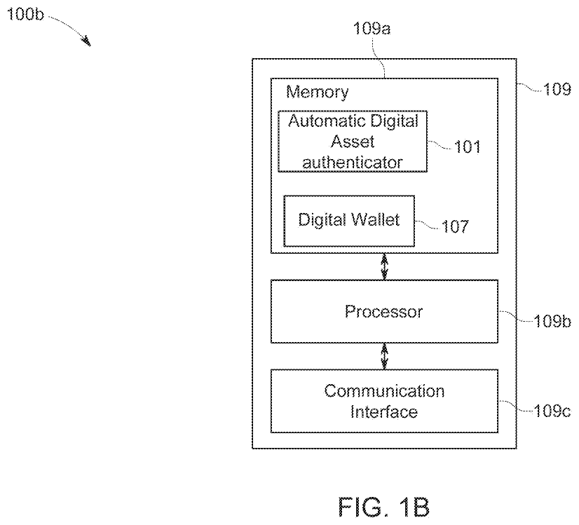

Turning now to FIGS. 1A-11C, a brief description concerning the various components of the present invention will now be briefly discussed. As can be seen in this embodiment, [overview—the widget includes part A part B and part C]. Reference will be made to the figures, showing various embodiments of a digital asset authenticator for authentication of media assets based on generation of non-fungible tokens (NFTs).

The present invention discloses an automatic digital asset authenticator that leverages a blockchain-based technology to automatically generate digital certificates of authenticity (hereafter referred to as a non-fungible token or an “NFT”) for digital media files (or digital assets), and further, keeps track of the generated NFTs. Generating the NFTs for the digital assets and keeping track of the NFTs provide a safeguard against the growing threat of deep fakes of the digital assets.

The NFT generated by the automatic digital asset authenticator is an immutable and a unique token. The NFT is encrypted on a blockchain network. Further, the NFT is an unalterable entity whose ownership rights are absolute and any transfers of ownership are traceable on the public blockchain. Therefore, in case an original digital asset (such as audio or video) with an original NFT is deep faked, then the deep faked digital asset will not have the original NFT or will have an NFT different from the original NFT of the original digital asset. Thus, media companies, small businesses, podcasters, governments, or the likes accidently publishing or broadcasting a digital asset that is fake can determine that the digital asset is illegitimate or fake. Further, viewers of the digital asset may be warned about illegitimacy of the digital asset being broadcasted. The automatic digital asset authenticator is described in detail below with reference to FIG. 1A.

Referring to FIG. 1A, a block diagram 100a of an automatic digital asset authenticator 101 is shown. Initially, a user 103 may send an original digital asset (or content) 105 created by the user 103 to the automatic digital asset authenticator 101. The automatic digital asset authenticator 101 is configured to automatically generate an NFT, for the digital asset 105, where the NFT certifies authenticity of the digital asset 105. The automatic digital asset authenticator 101 automates the generation of a single NFT in real-time for each piece or chunk of the digital asset 105 that is owned by the user 103, where the user 103 may be a creator and/or a publisher. In some embodiment, a batch of NFTs may be generated for the digital content 105. In an example embodiment, the automatic digital asset authenticator 101 may use relevant Application Programming Interfaces (APIs) and/or Smart Contracts for generation of the NFT.

The automatic digital asset authenticator 101 comprises an encoder 101a, an encryptor 101b, and an NFT Generator 101c. On receiving the digital asset 105, the digital asset 105 may be divided into discrete chunks, where length of each chunk may be predefined. In an example embodiment, length of the chunk is determined in real-time based on the length of the digital asset 105. In an example embodiment, the length of the discrete chunks is between 0.10 seconds and 3 seconds. Further, the automatic digital asset authenticator 101 uses the encoder 101a to encode each chunk of the digital asset 105 into, for example, base64 strings.

Base64 is a group of binary-to-text encoding schemes that represent binary data (more specifically, a sequence of 8-bit bytes associated with the digital asset 105) in an ASCII string format by translating the binary data into a radix-64 representation. The digital asset 105 encoded using the base64 strings may be stored/streamed in many other encoding formats and at varying quality levels or playback speeds. Further, the base64 encoded digital asset may be edited to omit some portions. Any variation in any of these aspects of the digital asset 105 will change the binary data/base64 strings of the digital asset 105. The base64 encoded strings of the digital asset 105 is equivalent to the digital asset 105, itself. Therefore, changing the underlying binary or base64 data will change the content of the digital asset 105, and vice versa. Thus, if the digital asset 105 is partially deep faked, the base64 strings of the corresponding fake chunk of the digital asset 105 will be different from that of the original base64 string corresponding to the original chunk of the digital asset 105, which may be used to detect fake digital asset.

It is noted that encryption is related to but not identical with hashing, and the output of Base64 should not be confused with the results of a hash algorithm. The length of the data (string) output by a given hash algorithm will always be the same, regardless of the input length. SHA 256 and similar hash functions are algorithms that are one-way, in that one cannot tell what the input was based on the output; but the has functions are deterministic, in that the same output is always given for the same input. The length of the output of a base64 encoding of an asset may vary in size based on the size of the original asset. Base64 encoding is not one-way, though the output of both Base64 encoding and SHA-512 may look similar (ascii strings of alpha numeric, case sensitive data).

Further, each discrete chunk of the digital asset 105 is assigned a distinct NFT. To that end, the automatic digital asset authenticator 101 uses the NFT generator 101c. The NFT generator 101c may implement a secure hash algorithm (SHA) 256. One example of such an algorithm would be SHA256, which generates a unique 256-bit (32-byte) signature for input data. The SHA256 may use base64 encoded chunk of the digital asset 105 as a seed to generate the corresponding NFT. For example, if the digital content 105 corresponds to a video, the video may be considered as a sequence of a plurality of short videos (or a plurality of chunks of the video). If NFTs are assigned to each chunk of the plurality of chunks of the video, then a NFT corresponding to each chunk may be linked to NFT corresponding to subsequent chunk in the plurality of chunks. In this way, a sequence of NFTs corresponding to the entire video comprising the plurality of chunks is created. Further, the NFT may be generated for real-time streaming of digital content and digital content stored in a database.

In case the digital asset 105 corresponds to a content being streamed live, the distinct NFT may be assigned in real-time as the discrete chunks of the digital asset are being streamed. In case the digital asset 105 is stored in a database and can be viewed by a viewer on-demand, the NFT may be already assigned to each chunk of the digital asset 105.

Further, the base64 encoded digital content and corresponding NFTs are stored in a digital wallet 107. The digital wallet 107 has a wallet address, where the wallet address includes a unique address that facilitates adding NFTs to the digital wallet 107. The digital wallet 107 may include an application or a hardware device that allows the user 103 to store and retrieve the digital asset 105 based on the wallet address.

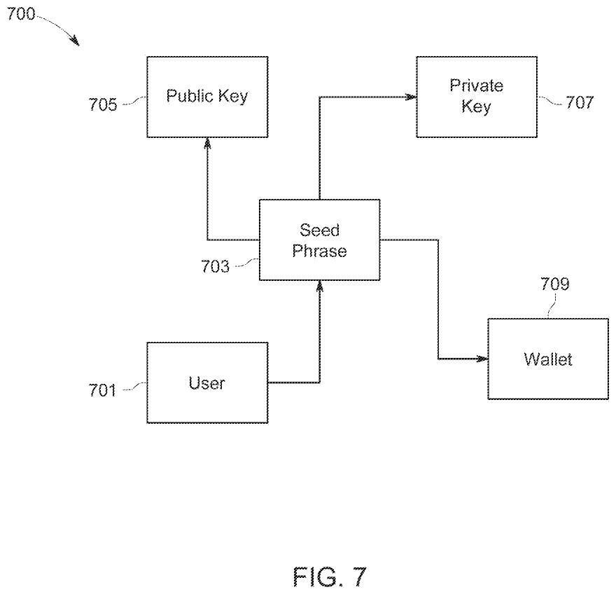

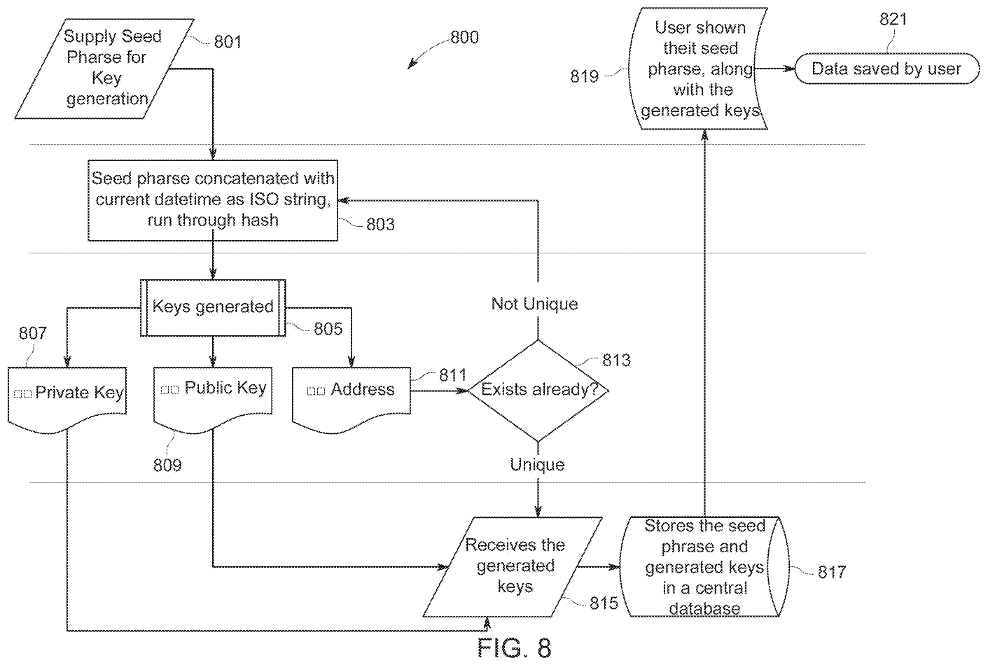

The automatic digital asset authenticator 101 further uses the encryptor 101b to encrypt the base64 encoded digital asset. The encryptor 101b generates encryption keys or keys (a private key and a public key) using a seed phrase. The private and the public keys are generated using a hash of the seed phrase. In some embodiments, the seed phrase comprises a collection of words in a key generator's language. The keys are used to encrypt the digital asset 105. The digital asset 105 may be encrypted to enable the user 103 to securely send the digital asset 105 to at least one of: another user, a social media platform, or a streaming media platform. The encryptor 101b may implement an encryption algorithm that supports long private keys such as 1024-bit Rivest-Shamir-Adleman (RSA) keys, 2048-bit RSA keys, 3072-bit RSA keys, and 15360-bit RSA keys, 80-bit symmetric keys, 112-bit symmetric keys, 128-bit symmetric keys, and 256-bit symmetric keys. A detailed description of the generation of encryption keys is provided later with respect to FIG. 7 and FIG. 8.

Some embodiments of the disclosed invention relate to a computing device that includes application programming interfaces (APIs), system runtime, operating system, and hardware components. APIs may be exposed by runtime components. The computing device may communicate with one or more other remote computing devices via network and communication links. A network represents any public or private communication network, for instance, a cellular, Wi-Fi, and/or other types of network for transmitting data between computing devices. The computing device and the remote computing devices may send and receive data across the network using any suitable communication techniques. For example, the computing device may be operatively coupled to the network using the communication link. The remote computing devices may be operatively coupled to the network by the communication link. The network may include network hubs, network switches, network routers, or the likes that are operatively inter-coupled thereby providing for the exchange of information between the computing device and the remote computing devices. In some examples, a custom smart contract will be created and deployed to the blockchain to define the terms of minting an NFT. Smart Contracts are a preferable element of minting NFTs in the presently disclosed invention, and in some embodiments are an inherent part of minting NFTs, with the API used preferably being a way to use an existing smart contract.

In some examples, communication links may be Ethernet, ATM, or other network connections. Such connections may be wireless and/or wired connections. Hardware components may include but are not limited to computer processors, communication units (e.g., modems, network interface controllers, and the like), input components, output components, a presence-sensitive display, volatile and non-volatile memories, and a power source to name only a few examples. An operating system may execute on hardware components and manage hardware and software components of the computing device. For instance, the operating system may perform memory management, process scheduling, and non-volatile storage management. The operating system may also provide network and security services to applications executing at the computing device. The operating system may also perform more or fewer functions than described above.

Further, a runtime system implements an execution model for applications that are built according to a particular programming language in which the applications are written and built or compiled. The runtime system may include one or more libraries and/or services that are accessible to application containers during execution. As further described in this disclosure, each application container may correspond to a distinct application. The runtime system may include thread-management services, screen drawing, and user-interface rendering a component, and inter-application messaging services, and intra-application messaging services. In some examples, the runtime system may be executed as one or more processes and/or threads. One or more of the processes and/or threads may execute with or without operating system privileges.

Referring to FIG. 1B, a block diagram 100b of a system 109 configured to authenticate the digital asset 105 is shown. The system 109 may include a processing module such as at least one processor 109b (hereinafter, also referred to as “processor 109b”), storage module such as at least one memory 109a (hereinafter, also referred to as “memory 109a”), and a communication module such as at least one communication interface 109c (hereinafter, also referred to as “communication interface 109c”). The processor 109b may retrieve computer program code instructions that may be stored in the memory 109a for the execution of the computer program code instructions.

The processor 109b may be embodied in several different ways. For example, the processor 109b may be embodied as one or more of various hardware processing modules such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (a field programmable gate array), a microcontroller unit (MCU), a hardware accelerator, a special-purpose computer chip, or the like. As such, in some embodiments, the processor 109b may include one or more processing cores configured to perform independently. A multi-core processor may enable multiprocessing within a single physical package. Additionally, or alternatively, the processor 109b may include one or more processors configured in tandem via the bus to enable independent execution of instructions, pipelining and/or multithreading.

Additionally, or alternatively, the processor 109b may include one or more processors capable of processing large volumes of workloads and operations to provide support for big data analysis and blockchain. In an example embodiment, the processor 109b may be in communication with the memory 109a via a bus for passing information among components coupled to the system 109.

The memory 109a may be non-transitory and may include, for example, one or more volatile and/or non-volatile memories. In other words, for example, the memory 109a may be an electronic storage device (for example, a computer readable storage medium) comprising gates configured to store data (for example, bits) that may be retrievable by a machine (for example, a computing device like the processor 109b). The memory 109a may be configured to store information, data, content, applications, instructions, or the like, for enabling the system 109 to carry out various functions in accordance with an example embodiment of the present invention. For example, the memory 109a may be configured to buffer input data for processing by the processor 109b.

As exemplarily illustrated in FIG. 1B, the memory 109a may be configured to store instructions for execution by the processor 109b. The memory 109a is further configured to store the automatic digital asset authenticator 101 and the digital wallet 107. As such, whether configured by hardware or software methods, or by a combination thereof, the processor 109b may represent an entity (for example, physically embodied in circuitry) capable of performing operations according to an embodiment of the present invention while configured accordingly. Thus, for example, when the processor 109b is embodied as an ASIC, FPGA or the like, the processor 109b may be specifically configured hardware for conducting the operations described herein. Alternatively, as another example, when the processor 109b is embodied as an executor of software instructions, the instructions may specifically configure the processor 109b to perform the algorithms and/or operations described herein when the instructions are executed. However, in some cases, the processor 109b may be a processor specific device (for example, a mobile terminal or a fixed computing device) configured to employ an embodiment of the present invention by further configuration of the processor 109b by instructions for performing the algorithms and/or operations described herein. The processor 109b may include, among other things, a clock, an arithmetic logic unit (ALU) and logic gates configured to support operation of the processor 109b.

The communication interface 109c may comprise input interface and output interface for supporting communications to one or more remote computing systems/devices from the system 109. The communication interface 109c may be any module such as a device or circuitry embodied in either hardware or a combination of hardware and software that is configured to receive and/or transmit data to one or more remote computing systems/devices from the system 109. In this regard, the communication interface 109c may include, for example, an antenna (or multiple antennae) and supporting hardware and/or software for enabling communications with a wireless communication network. Additionally, or alternatively, the communication interface 109c may include the circuitry for interacting with the antenna(s) to cause transmission of signals via the antenna(s) or to handle receipt of signals received via the antenna(s). In some environments, the communication interface 109c may alternatively or additionally support wired communication. As such, for example, the communication interface 109c may include a communication modem and/or other hardware and/or software for supporting communication via cable, digital subscriber line (DSL), universal serial bus (USB) or other mechanisms.

The system of FIG. 1B may be used for authentication of digital assets using the NFTs generated by the process described briefly above and outlined later in various embodiments.

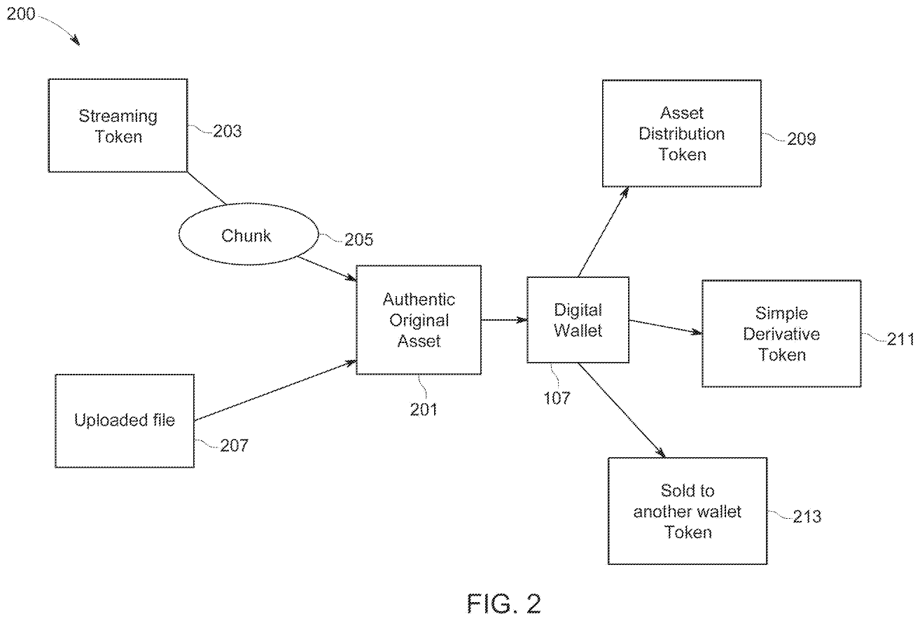

Further, there are different types of NFTs. The different types of NFTs are described below with reference to FIG. 2.

Referring to FIG. 2, a schematic diagram 200 of different types of NFTs is shown. FIG. 2 is described below in conjunction with FIG. 1. The NFTs may be categorized into different types based on at least one of: a type of the digital asset 105 or an entity to which the digital asset 105 is shared, where the entity may comprise a social media platform or one or more users. For example, when the digital asset 105 corresponds to a streaming media, streaming tokens 203 are generated by the automatic digital asset authenticator 101. The streaming tokens 203 may be generated for each chunk 205 of the streaming media, where each chunk 205 may be encoded by base64 scheme. Further, each chunk 205 of the streaming media may correspond to each image or each frame of the digital asset 105.

In some embodiments, when the user 103 attempts to mint a large digital asset (for example, the digital asset 105) that cannot fit into an NFT, the automatic digital asset authenticator 101 will mint an NFT for a first portion (or a chunk 205) of the digital asset 105 and then increment its nonce. The automatic digital asset authenticator 101 will continue minting NFTs for each additional portion/duration of the asset until the end of the digital asset 105 is reached. Therefore, at the end of minting NFTs for the digital asset 105, the user 103 will have sequenced NFTs of each portion/duration (or chunks 205) of the digital asset 105 minted with corresponding NFTs. The sequence of NFTs (corresponding to sequence of chunks 205 of the digital asset 105) is handled by causing the digital asset 105 to spin up its own internal sidechain, or by having the automatic digital asset authenticator 101 keep track of the minted NTFs (i.e., the sequence of NFTs) and the sequence with which the sequence of chunks 205 should be played back.

Further, the streaming media with a series of streaming tokens 203 are stored as an authentic original asset 201. The series of streaming tokens 203 are stored in the digital wallet 107. The user 103 may then send the authentic original asset 201 (for example, the streaming media) to a streaming media platform. To that end, the automatic digital asset authenticator 101 may use the encryptor 101b to generate a private stream key and a public stream key to encrypt the streaming media before sending the streaming media to the streaming media platform.

The streaming tokens 203 may be generated based on one or more or all of the following inputs: 1) the private stream key used to send the digital asset 105 from a stream host to a stream/restreaming platform; 2) credentials of the digital wallet 107, storing the NFTs for the streaming media, that will own the next predetermined duration of the streaming media; 3) a destination URL of outgoing stream of digital asset 105; 4) a precise start time of the stream; 5) a hardware MAC address of a computer that started the stream; 6) binary or base64 encoded strings representing the next predetermined duration of the streaming media; and 7) a reference to the previous segment of streaming media.

Further, the authentic original asset 201 may correspond to an uploaded file 207, where the uploaded file 207 may comprise digital media which is authenticated by the automatic digital media authenticator 101. The user 103 may decide to share the digital asset 105 created by the user 103 with one or more social media platforms.

To that end, the user 103 will associate the digital wallet 107 (owned by the user 103 to store encoded digital asset 105 and corresponding NFTs) to the one or more social media platforms. The user 103 must grant the one or more social media platforms the rights to generate a simple derivative token 211 of the digital asset 105 that the user 103 may upload to the one or more social media platforms, where the one or more social media platforms may use encoding/quality or other settings for the digital asset 105 uploaded by the user 103. The one or more social media platforms are required to send back the simple derivative token 211 generated by the corresponding one or more social media platforms to the wallet address of the digital wallet 107. Further, the one or more social media platforms are required to specify any cuts/trims the one or more social media platforms may have done (such as removing leading/trailing silence and/or black screens), an encoding type used to encode the digital asset 105, an encoding algorithm the one or more social media platforms used to generate the simple derivative token 211, and any applicable quality settings the one or more social media platforms used.

Further, an asset distribution token 209 is another type of NFT that is used to grant permission to another user to post/broadcast the authentic digital asset 201 owned by the user 103. To that end, the asset distribution token 209 is used to associate the authentic original digital asset 201 to a digital wallet of another user. The digital wallet 107 is configured to control distribution of the authentic digital asset 201 and any associated asset distribution token 209 including the ability to disassociate the asset distribution token 209 from any digital wallet the asset distribution token 209 may be associated with. The asset distribution token 209 is related to binary data of the authentic original digital asset 201, allowing the authorized digital wallet 107 to use the authentic original digital asset 201 on any platform and have the authentic original digital asset 201 converted to such platform's needed file type/encoding/quality and associated back to the asset distribution token 209 as described above for the posting of the authentic original digital asset 201 by another user.

Further, a sold to another wallet token 213 may be generated by the automatic digital asset authenticator 101 when the user 103 has sold the digital wallet 107 owned by the user 103 to another user.

In some embodiments, a large media (e.g., a video or a livestream) broken into a plurality of chunks and minted as NFTs may become its own (limited/mini) blockchain. A first chunk of the plurality of chunks may be added to the mini blockchain and hashed as usual. That would continue until the end of the large media (or media), at which point a final hash would be known for the full media file. Knowing a hash for the full media file allows for easy checks of “exact duplicates” of the large video or livestream. Because irrespective of the size of the hash input, the output will always be the same. However, since each chunk of the media is also hashed when it is added to the mini blockchain, that allows original content creators to detect another media where most of the content matches.

Further, if some metadata is also included in each chunk of the media, where the metadata may comprise information associated with what an image in a video frame of the video or live stream media would sum up to, finger print of audio corresponding to the video frame, or the likes, it is possible to detect another media where the content diverges from the original media (i.e., a faked media can be detected), for example in cases where a faked video has vast quality differences from the original video.

In another embodiment, if an owner of a digital asset wants to post the digital asset on a social media platform or post the digital asset as a commercial, the owner may post it to a publicly visible decentralized blockchain storage. To that end, the owner may use its digital wallet to show the digital asset owned by the owner. However, if the owner of the digital asset wants the digital asset to be private, the digital asset may be hashed before posting it to the blockchain and adding the digital asset to the digital wallet of the owner.

Further, to handle ownership disputes related to the digital asset, the owner may be required to keep a copy of the original digital asset. Later, when another entity, for example a user, tried to claim the digital asset already privately claimed by the owner, the owner could demonstrate their ownership of the digital asset by showing that the owner possesses a file that will produce the same hash output as the privately claimed digital asset in the digital wallet of the owner. Thus, they could prove they owned the digital asset first.

In some embodiments, the automatic digital asset authenticator 101 may be implemented in wearable devices such as Google Glass or head mounted displays (HMDs) that provides virtual reality interfaces, where the automatic digital asset authenticator 101 enables the wearable devices to compare fingerprint of a digital asset being viewed on the wearable devices against a known published digital asset to detect deep fakes or false postings.

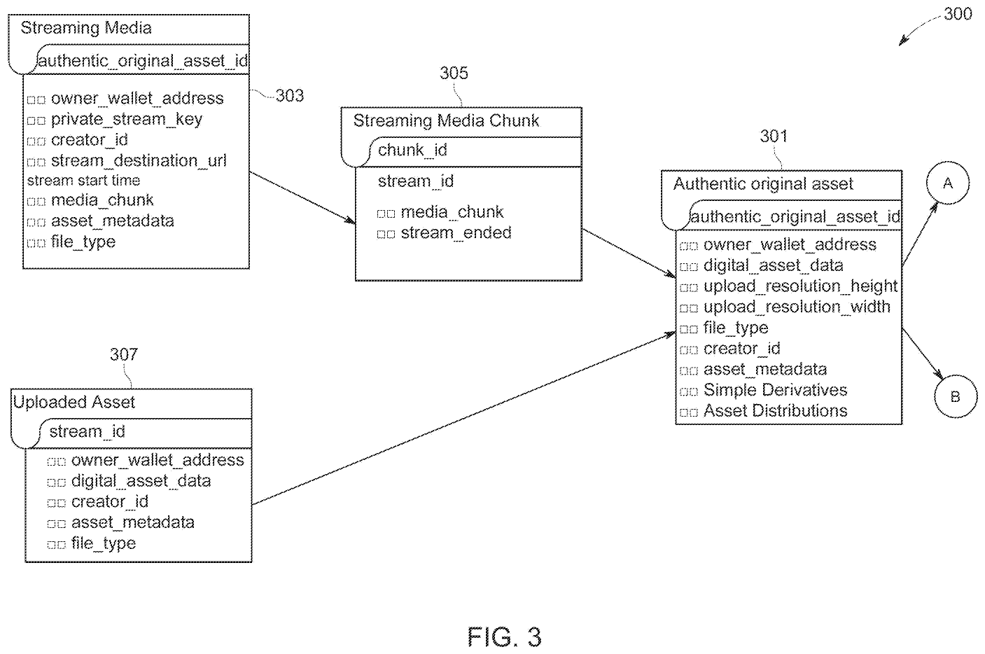

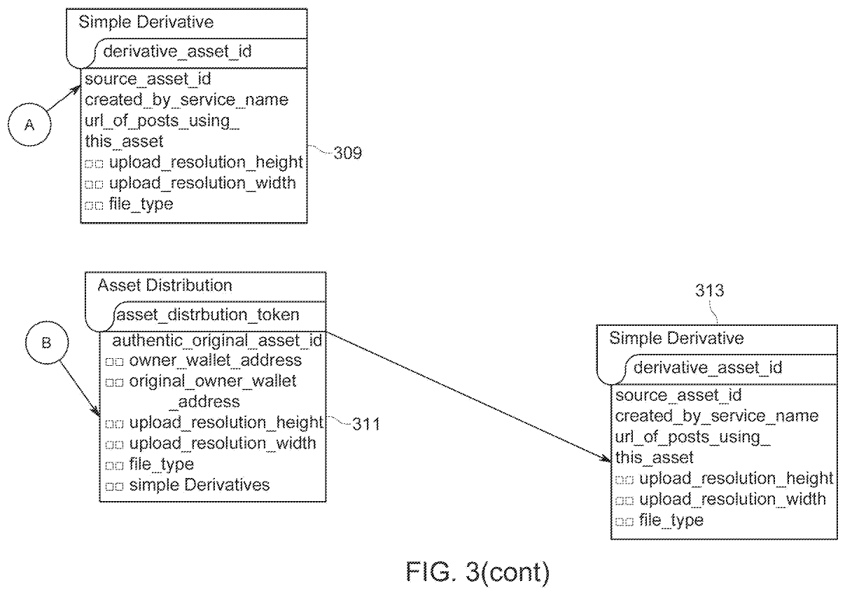

Referring to FIG. 3, a schematic diagram of contents of: an authentic digital asset 301, streaming media token 303, a streaming media chunk 305 associated with the streaming media token 303, an uploaded asset 307, a simple derivative token 309 associated with the authentic digital asset 301, an asset distribution token 311, and a simple derivative token 313 associated with the asset distribution token 311, are shown. The authentic original digital asset 301 preferably comprises at least one of: owner (i.e., the user 103) wallet address, digital asset data, upload resolution height, upload resolution width, file type, creator id, asset metadata, simple derivatives, and asset distributions.

Further, the streaming media token 303 preferably comprises at least one of: owner wallet address, private stream key, creator id, stream destination URL, stream start time, media chunk, asset metadata, file type. The streaming media chunk 305 preferably comprises at least one of: chunk id, stream id, media chunk, stream end. The uploaded asset 307 may comprise at least one of: owner wallet address, digital asset data, creator id, asset metadata, file type. Further, the asset distribution token 311 may comprise at least one of: authentic original asset id, owner wallet address, original owner wallet address, upload resolution height, upload resolution width, file type, and simple derivatives.

Further, the simple derivative token 309 associated with the authentic original digital asset 301 and the simple derivative 313 associated with the asset distribution token 311 may comprise at least one of: derivative asset id, source asset id, upload resolution height, upload resolution width, and file type.

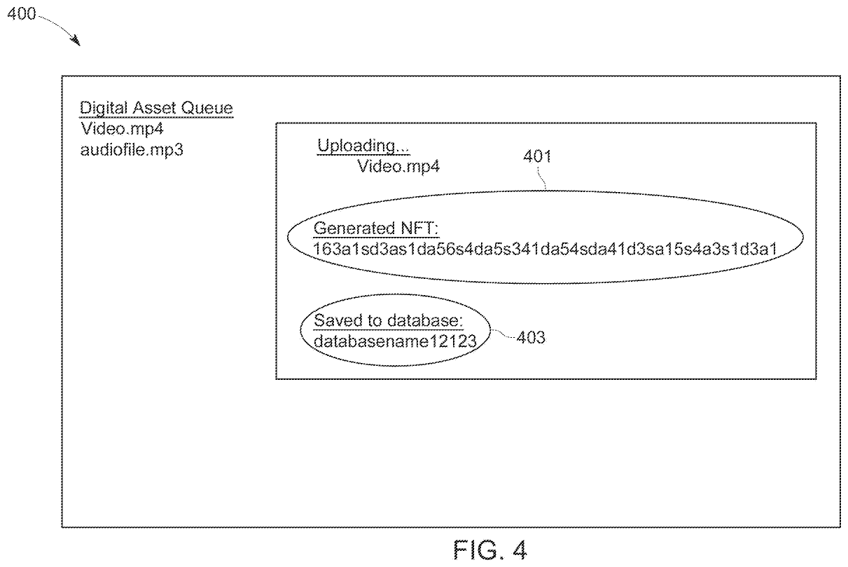

Referring to FIG. 4, a graphical user interface (GUI) 400 for a system for generating NFTs, along with an NFT 401 generated for a media asset is shown. In FIG. 4, the user 103 uploads the media asset “video.mp4” owned by the user 103 on the automatic digital asset authenticator 101. The automatic digital asset authenticator 101 encodes the uploaded media asset using the base64 encoding scheme and generates the NFT 401 using SHA256 hashing algorithm. The generated NFT 401 is stored in a database 403 (or the digital wallet 107) “database 12123” along with the encoded media asset. In some embodiment, the media asset is segmented into chunks of predefined length, and an NFT is generated for each chunk. Further, NFTs corresponding to all the chunks of the media asset are stored in the digital wallet 107.

In some embodiments, size of an NFT is based on a type of the digital asset 105 and a size of the digital asset 105. For example, the type of the digital asset 105 may comprise audio digital asset, video digital asset. Further, the size of the digital asset 105 may differ based on type of the digital asset 105. For example, a size of a 4K HD digital video asset is likely more than a size of MP4 digital video asset of a same number of frames. In case of a 4K HD video, each frame size is 162 kB, and an audio portion of each frame is approximately 2.82 kB. Thus, the 4K HD video will have each video frame of 162 kB and corresponding audio of 2.82 kB summing up just under 165 kB. Thus, the size of the NFT may be at least 165 kB.

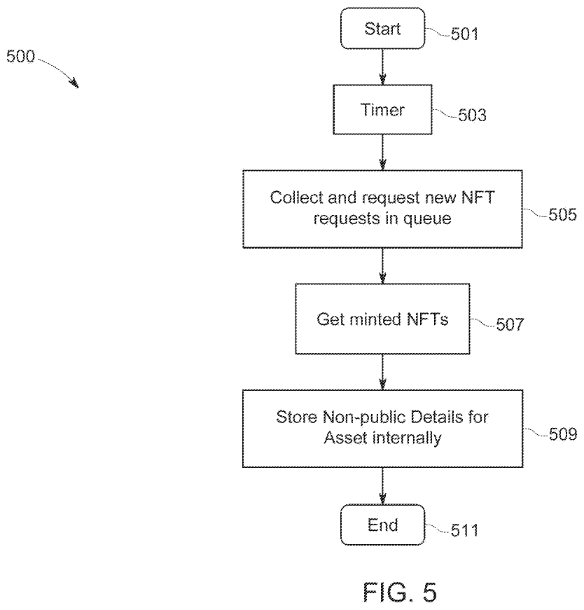

Referring to FIG. 5, a workflow 500 of generation of NFT by the automatic digital asset authenticator 101 at a high level is shown. FIG. 5 is described below in conjunction with FIG. 1. The workflow 500 starts at step 501. At step 503, a timer job waits till the user 103 uploads its digital asset 105 to the automatic digital asset authenticator 101. At step 505, new NFT requests in queue may be collected and requested. At step 507, the NFTs are minted. The automatic digital asset authenticator 101 uses the NFT generator 101c to generate (or mint) NFT to the digital asset 105 uploaded to the automatic digital asset authenticator 101. At step 509, non-public details for the digital asset 105 may be stored internally. The non-public details may be stored in the digital wallet 107. The workflow ends at step 511.

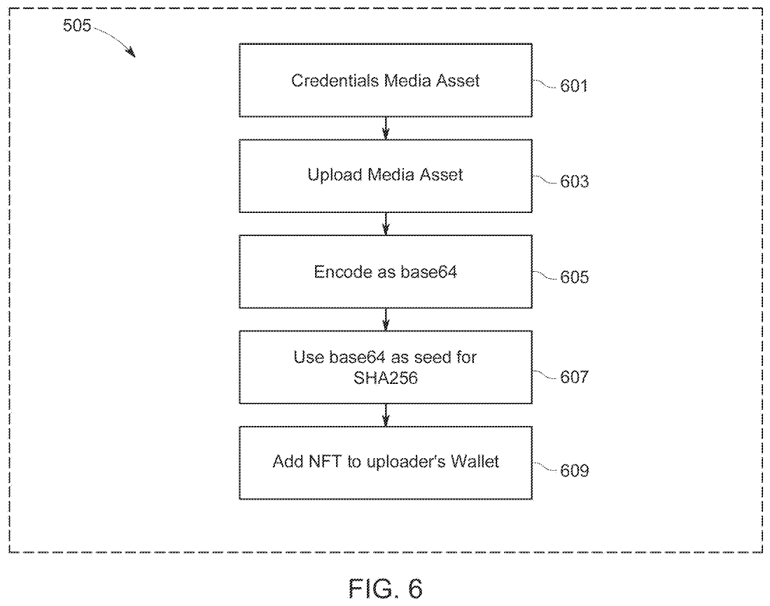

Referring to FIG. 6, a workflow of collecting and requesting new NFT requests in the in queue 505 of workflow 500 is show in greater detail. The workflow 505 comprises, at step 601, the user 103 may enter his credentials to login into the automatic digital asset authenticator 101 and the corresponding digital wallet 107. Further, at step 603, a media asset such as the digital asset 105 may be uploaded to the automatic digital asset authenticator 101. At step 605, the media asset may be encoded using base64 encoding scheme. To that end, the media asset may be segmented into a plurality of chunks and each chunk is encoded using base64 encoding scheme. At step 607, base64 string for a chunk of the plurality of chunks may be used as a seed for SHA256 hashing algorithm to generate an NFT for the chunk. Similarly, a sequence of NFTs for remaining chunks of the plurality of chunks may be generated. Finally, at step 609, all the NFTs generated at step 607 are added (or stored) to the digital wallet 107.

In some embodiments the digital asset 105 is encrypted using the private key and the public key generated using the seed, to enable secure sharing of the digital asset 105 with another user, social media platforms, streaming media platforms, and the likes.

In an example embodiment, an entity generates a video and posts it to entity's social media channels and falsely claims that the video was captured directly from the spoofed content publisher/creator, where the entity may be another user, social media platform, streaming media platform, or the likes. Thus, the video posted by the entity is a fake video of an original video created by original content creator. The present invention enables the original content publisher/creator to demonstrate that the video posted by the entity on its social media channels is fake. Because according to embodiments of the present invention, the content creator must ensure that all new content that the creator publishes are authenticated or minted with NFT by the automatic digital asset authenticator. By using the automatic digital asset authenticator, the creator generates NFTs for each portion of content in the creator's published back-catalog. This enables the content creator to file a claim with the video broadcasted on the social media platform by the entity is a fake video and is falsely claimed to be from the original content creator. The original content creator can prove that the video is fake by checking NFT of the alleged fake video. The fake video will either have no NFT or its NFT will be different from original video created by the content creator. In this way, the fake video is detected using embodiments of the present invention.

In another example embodiment, the entity generates a fake video, in real-time, by hijacking the live stream of a legitimate creator. The entity may replace the hijacked live stream with entity's own AI-generated content without any indication to the viewer. The present invention enables the legitimate creator and/or other platforms such as social media platform and streaming media platform re-streaming the live stream to detect that the video being streamed is faked. Because according to the embodiments of the present invention, the legitimate creator securely associates a private stream key used by the legitimate creator to stream to social media platform or the streaming media platform with a digital wallet, of the legitimate creator, used for storing NFTs. A streaming host or a computer recording the live stream to be sent to other platforms uses the automatic digital asset authenticator that continually segments the live streamed content into chunks of a predetermined length (for example, 1 second, 3 seconds, or the likes). Further, the automatic digital asset authenticator encodes each chunk into base64 strings by using base64 encoding scheme, generates an NFT for each chunk, and stores the base64 encoded strings of the live streamed content along with the NFTs for each chunk of the live streamed content in the digital wallet of the legitimate creator. Further, a separate process is employed by the automatic digital asset authenticator to send the live streamed content for outgoing stream directly to the social media platform or the streaming media platform using the private streaming key.

It is possible that the entity has hijacked the private streaming key and is replacing digital content of the live streamed content that the legitimate creator intends to stream with a false content desired by the entity. However, the base64 encoded strings of each second of the live streamed content replaced by the entity will not match the base64 encoded strings found for that moment in the digital wallet of the legitimate creator. Thus, the social media platforms or the streaming media platforms streaming the live streamed content detects that the live streamed content is being faked based on the base64 encoding strings. Accordingly, the platforms may warn its viewers and streamers that the live streamed content is being faked.

In some embodiments, a legitimate entity may associate many versions of a video created by the legitimate entity (for instance, 1-3 resolutions/quality levels of the same video, or the same video encoded using various protocols like MP4, AVI, or MOV all to the same NFT) with its digital wallet. It is preferable to associate many versions of the video to the digital wallet because for instance, if a user uploads and shares a video to Facebook™, Facebook™ will likely standardize the video file format and encoding quality. Even though the original video that the user uploaded matched the Facebook™ desired output format and quality. Standardizing the video will result in a copy of the video generated by the Facebook™ with a different base64 encoded string for the user's video. Therefore, the user may upload the video along with its NFT token to the Facebook™ or any other desired social media platform associated with the digital wallet of the user.

Further, any digital asset uploaded to a social media platform with an NFT that is not associated with a digital wallet associated with profile of a user who uploaded the digital asset may be flagged for removal based on the preferences specified in an original digital wallet that owns the NFT to the uploaded digital asse. The social media platform may respond to a content shared on the social media platform by a creator with an NFT token generated by the social media platform for the content shared by the creator. The NFT token generated by the social media platform will be associated as a simple derivative of NFT of the original content shared by the creator. Thus, the present invention effectively detects and blocks un-authorized posting or re-posting of any digital asset.

In an example embodiment, there is the scenarios where a digital asset is found out on a platform (social media platform or the streaming media platform) where it is suspected to be an unauthorized copy or partial deepfake. If a file type of the digital asset is known, the encoding algorithm used by the platform on which a copy of the digital asset was found, and the platform's standard quality settings were determined, it is possible to compare binary data (base64 strings) representing the digital asset found on the platform to binary data (base64 strings) expected for a known authentic original digital asset converted to the same file type, using the same encoding algorithm, and similar quality settings. Thus, unauthorized copies of some asset (pirated assets), or assets where only a portion of the asset's duration is different from what was expected after applying a similar conversion to a known authentic original digital asset (suspected deep fakes) can be found. Thus, it may be determined whether the copy was authentic or a copy or a fake.

In an example embodiment, media uploaded by an unverified poster may be determined by matching at least one of: the binary data expected if a known authentic original digital asset was downloaded in full quality, re-encoded to another format/quality, and then uploaded to a web platform, or the binary data expected if a simple derivative associated to an authentic original asset was downloaded at the quality of that simple derivative, then re-encoded to another format/quality, and finally uploaded to a web platform.

In an example embodiment, a user equipment like smartphone may use the automatic digital asset authenticator to automatically mint all media (such as photos, videos, or the likes) with single NFT or digital certificate of authenticity.

In another example embodiment, the automatic digital asset authenticator may generate a QR code that is linked to a digital asset being viewed on a social media profile of an entity. The QR code may be used to validate that the social media profile and may be linked to a digital wallet of a user that owns the digital asset. The QR code may be incorporated in the digital asset as a watermark or a small graphics at a corner of the digital asset.

In another example embodiment, the automatic digital asset authenticator may be used to generate NFTs for email to enable the recipient of the mail to verify authenticity of an entity whose sent the email.

Further, generation of the private key and the public key used to encrypt the digital asset 105 is described at a high level below with reference to FIG. 7.

Referring to FIG. 7, a high-level block diagram 700 for generating encryption keys is shown. Initially, the automatic digital asset authenticator 101 receives inputs from a user 701 (the user 701 corresponds to the user 103 inf FIG. 1), where the user 701 inputs at least one character. In some embodiments, number of characters to be inputted by the user 701 is predetermined. Based on the at least one character inputted by the user 701, the automatic digital asset authenticator 101 generates a seed phrase 703. Further, based on the seed phrase 703, a private key 707 and a public key 705 are generated. To that end, a hash of the seed phrase 703 is performed. The seed phrase 703 may be stored in a digital wallet 709 (the digital wallet 709 corresponds to the digital wallet 107). A detailed description regarding generation of the encryption keys is provided below with respect to FIG. 8.

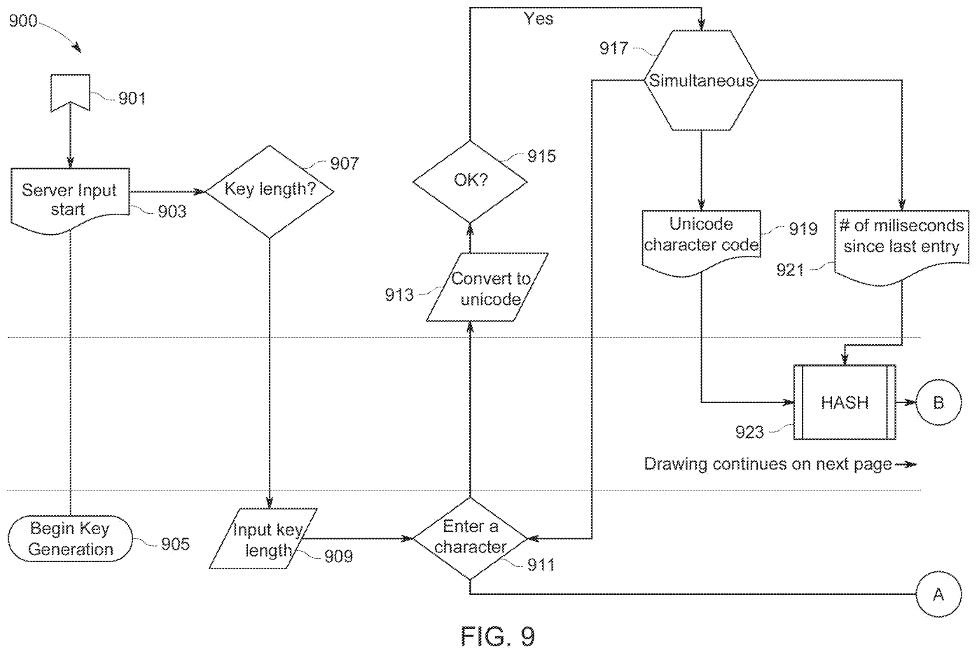

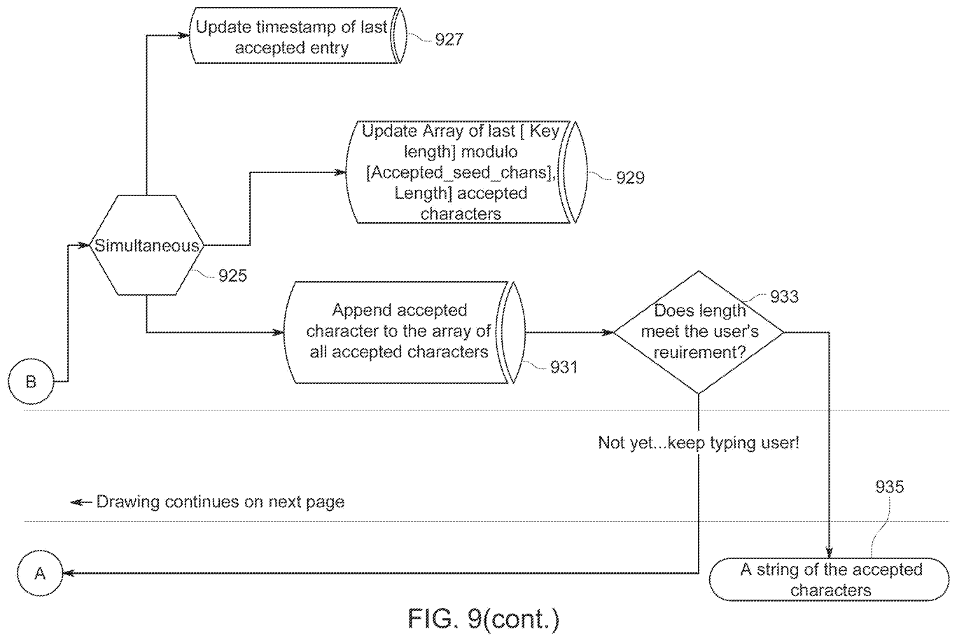

Referring to FIG. 8, a detailed workflow 800 for the generation of encryption keys and storage of the encryption keys is shown. FIG. 8 is described in conjunction with FIG. 1. At step 801, a seed phrase for key generation is supplied to the automatic digital asset authenticator 101. The generation of seed phrase is described later with respect to FIG. 9. The seed phrase supplied to the automatic digital asset authenticator 101 corresponds to the seed phrase 703 in FIG. 7. At step 803, the seed phrase may be concatenated with current data and time as an ISO string. Further, the seed phrase is run through a hash function to generate keys at step 805. Hashing the seed phrase generates a private key at step 807, a public key at step 809, and a wallet address 811. The wallet address 811 corresponds to the digital wallet 107. The wallet address 811 is used to store the private key, the public key, along with NFTs for the digital asset 105 in the digital wallet 107.

At step 813, it may be determined whether the address 811 exists, i.e., whether the address 811 is unique or not. In case the address 811 is not unique, the workflow 800 loops back to step 803. In case, the address 811 is unique, the workflow 800 proceeds to step 815. At step 815, the private key, the public key, and the address may be received. Further, at step 817, the seed phrase and the generated encryption keys may be stored in a central database. In some embodiment, the seed phrase and the generated encryption keys may be stored in the digital wallet 107. At step 819, the user is shown the seed phrase along with the generated encryption keys. The user may just use the seed phrase for encrypting the media asset while sending the media asset to other entities. At step 821, the seed phrase along with the generated keys may be saved by the user. Further, a detailed description regarding a seed (or a seed phrase) generation process is described below with reference to FIG. 9.

Referring to FIG. 9, another workflow 900 for seed generation is shown. The workflow 900 starts at step 901. At step 903, input start time is saved as a user initiates key generation at step 905. At step 907, a length of a key is determined. The user may initiate the key generation by inputting a key length desired by the user at step 909. Further, the user may be required to randomly enter one or more characters at step 911. In one embodiment, when the user inputs one or more characters, the inputted one or more characters are compared to a record of previously accepted input characters. If currently inputted one or more characters are not repeated in the limited record of accepted characters, the currently inputted one or more characters are accepted. In some embodiments, the maximum length of the accepted characters in the record is defined as (Desired Key Length)/X, where X is a configurable parameter and the value of X may be at least one of 16, 32, 64, 256, or 512.

When the inputted one or more characters are accepted, at step 913 the inputted one or more characters may be converted to Unicode characters. At step 915, it may be determined whether the Unicode characters corresponding to the inputted one or more characters are correct. When the Unicode characters are correct, then Unicode character code 919 is determined simultaneously 917 with the amount of time 921 in millisecond passed since entry of the last character.

The accepted one or more characters are combined into a JSON object comprised of two input parameters 919 and 921: the Unicode character code of the accepted one or more characters and the amount of time in millisecond passed since entry of the last character. Further, the JSON object consisting of the two input parameters 919 and 921 are pushed to an array. The length of the array is checked to see whether the length meets the user's desired key length. If the length of the array meets the desired key length, the array of JSON objects is used as a seed to generate the public and private key along with a public address hash as illustrated in FIG. 8 with steps 801-809.

At step 923, a hash algorithm is performed on the Unicode character code 919 and the amount of time 921 in milli-second passed since entry of the last character. The hash algorithm simultaneously 925 performs steps 927, 929, and 931. At step 927, a timestamp of the last accepted entry may be updated. At step 929, the array of last [Key Length] modulo [Accepted_Seed_Chars]. [Length] accepted characters may be updated. At step 931, accepted one or more characters may be appended to the array of all accepted characters. At step 933, it may be determined whether the length of the array of all accepted characters meets the user's requirement. If the length of the array is as per the requirements of the user, at step 935, a string of the accepted one or more characters is formed. If the length of the array is not as per the requirements of the user, the workflow 900 loops back to step 911, where the user is requested to input more characters.

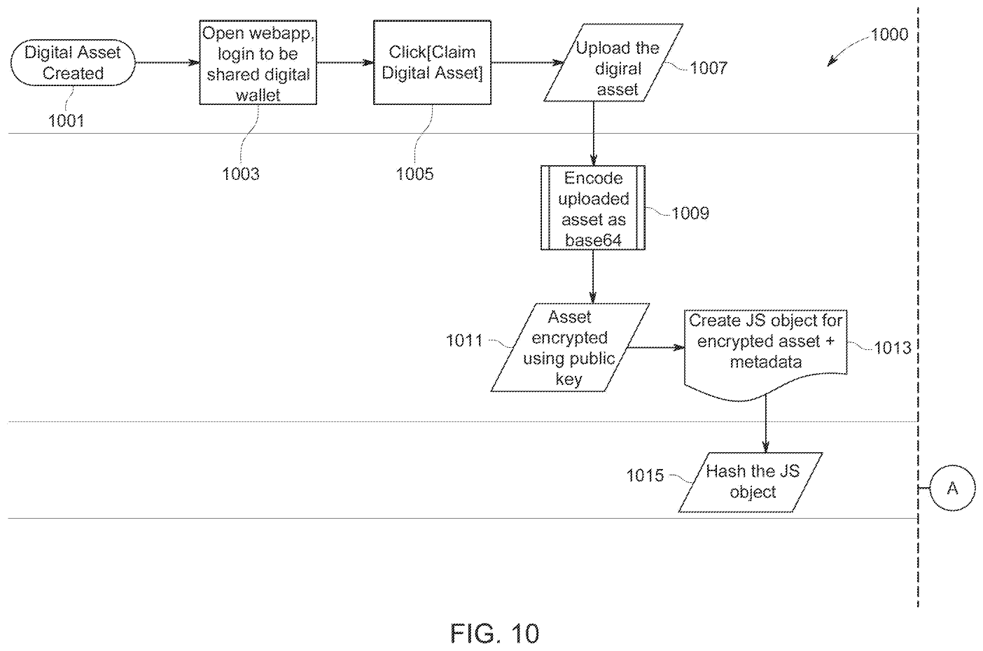

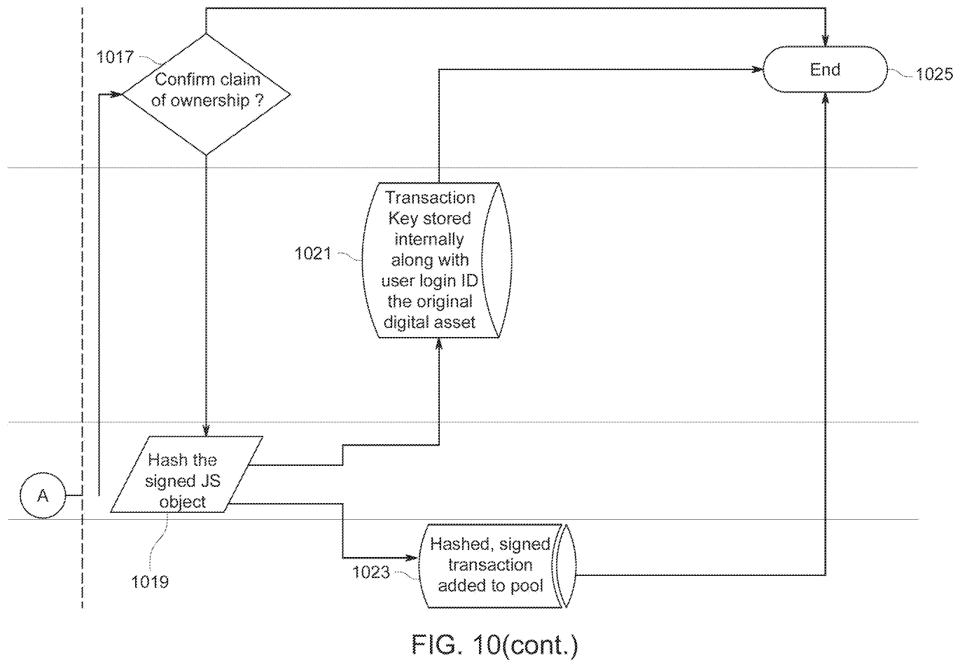

Referring to FIG. 10, a workflow 1000 for claiming authorship of the digital asset 105 is shown. FIG. 10 is described in conjunction with FIG. 1. The workflow 1000 starts at step 1001, where the digital asset 105 is created. At step 1003, the user 103 may log in to the digital wallet 107. To log in to the digital wallet 107, the user 103 may open a web application, where the user 103 may input its credentials or login details. At step 1005, the user 103 may select to claim the digital asset 105. To that end, the web application may display on a display screen a user interface that provides an option of “Claim Digital Asset”. The user 103 may click “Claim Digital Asset” to select the digital asset 105 to claim. At step 1007, the selected digital asset 105 is uploaded to the automatic digital asset authenticator 101.

At step 1009, the uploaded digital asset 105 is encoded using the base64 encoding scheme. At step 1011, the encoded digital asset is encrypted using a public key (generation of the public key for encryption is explained earlier with reference to FIG. 7 and FIG. 8). At step 1013, a JS object may be created for the encrypted digital asset along with metadata associated with the digital asset 105.

At step 1015, a hash algorithm may be performed on the JS object. At step 1017, the user may be required to confirm whether the user wants to claim ownership of the digital asset 105. In case the user does not want to claim ownership of the digital asset 105, the workflow 1000 ends at step 1025. However, if the user decides to claim ownership of the digital asset 105, the JS object may be signed with a wallet address of the digital wallet 107. Further, the workflow 1000 proceeds to step 1019. At step 1019, a hash algorithm is performed on the signed JS object. The hashing algorithm performs steps 1021 and 1023, simultaneously. At step 1021, a transaction key along with user login id, the digital asset 105 may be stored internally. At step 1023, a transaction that is hashed and signed may be added to a pool of blockchain, and the workflow 1000 ends at step 1025.

Some embodiments are based on a realization that it is possible that multiple users may claim authorship of publicly visible digital asset via blockchain. To resolve issue of the multiple users claiming authorship one digital asset, a consensus mechanism may used. The consensus mechanism may be implemented by the automatic digital asset authenticator 101. The consensus mechanism includes protocols and/or algorithms that allows distributed/networked systems of computers to work together and stay secure. Further, the consensus mechanism helps prevent economic attacks such as “51% attack,” where it is possible that an attacker may compromise consensus by controlling 51% of the network.

Further, the consensus mechanism helps users avoid repeat transactions or repeated generation of NFTs. The repeated generation of NFTs i.e., multiple NFTs cost CPU credits to a user and further, the multiple NFTs may cause a digital wallet or a content library of the user to contain duplicate NFTs.

In some embodiments, for a user to make NFTs, the user requires a digital asset that the user wants to authenticate or generate NFT for, a wallet address of a wallet to which the user wishes to deposit or store the generated NFT, and a method to sign NFT transaction with the address of the digital wallet of the user. However, if the user wants to ensure that no other users have claimed the digital asset already claimed by the user, a shared transaction pool is preferable to have a way to check the known database of assets, preferable without a bunch of heavy CPU work. This is possible if the digital asset is posted to the blockchain and encrypted using a known public key shared by all users (for which the blockchain knows the private key).

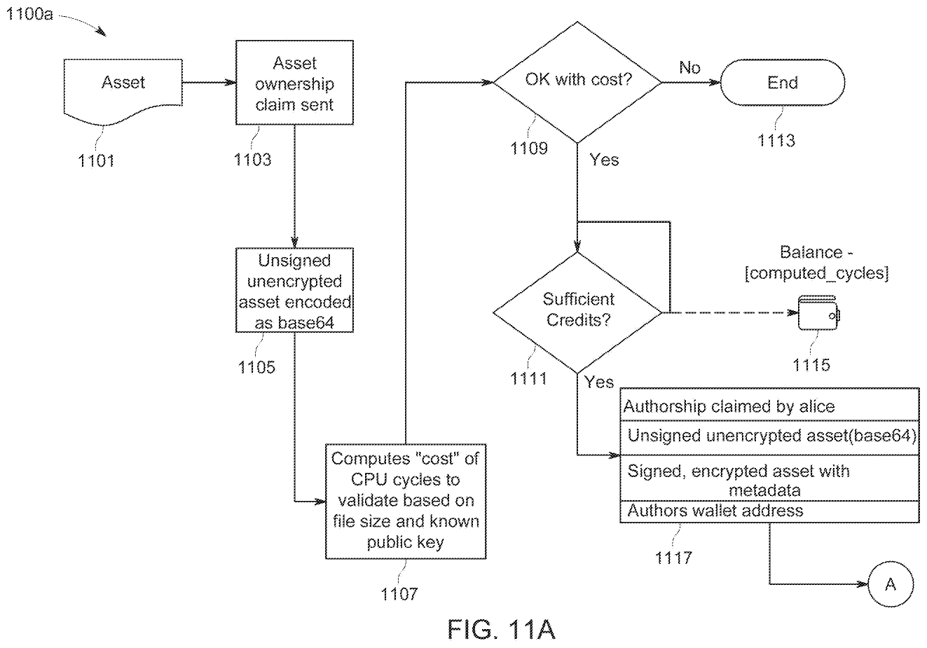

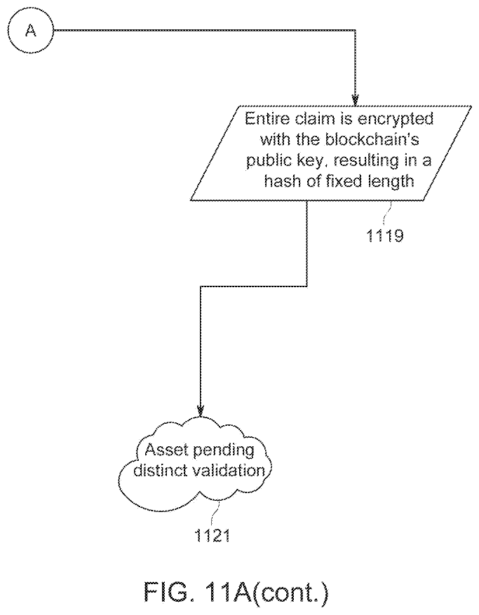

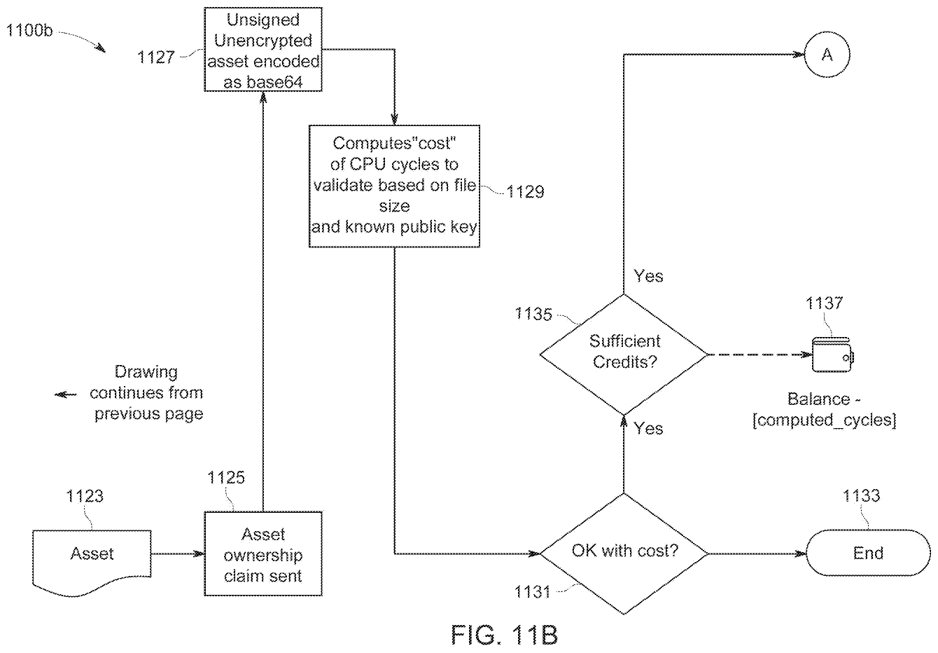

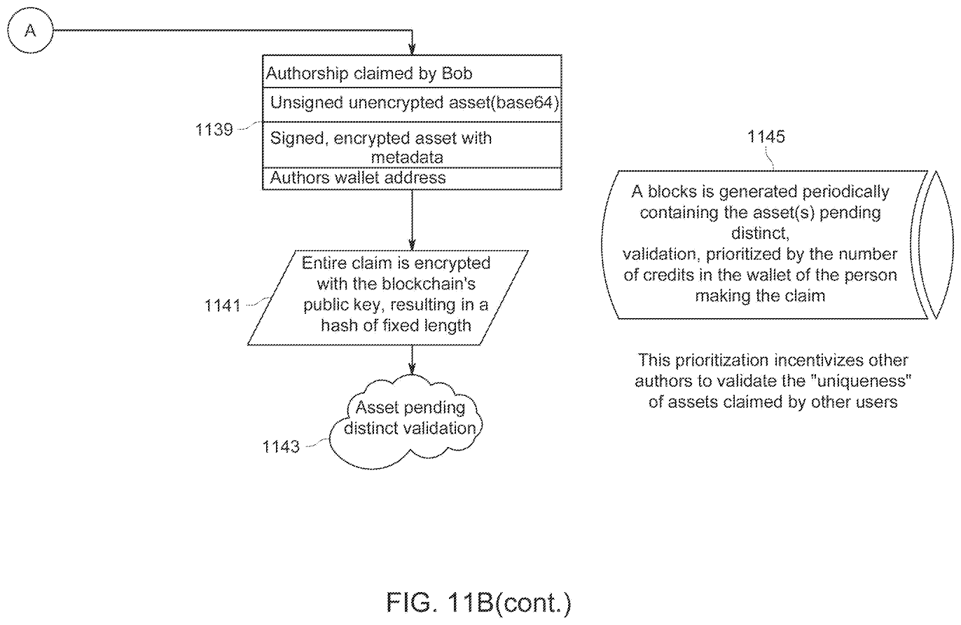

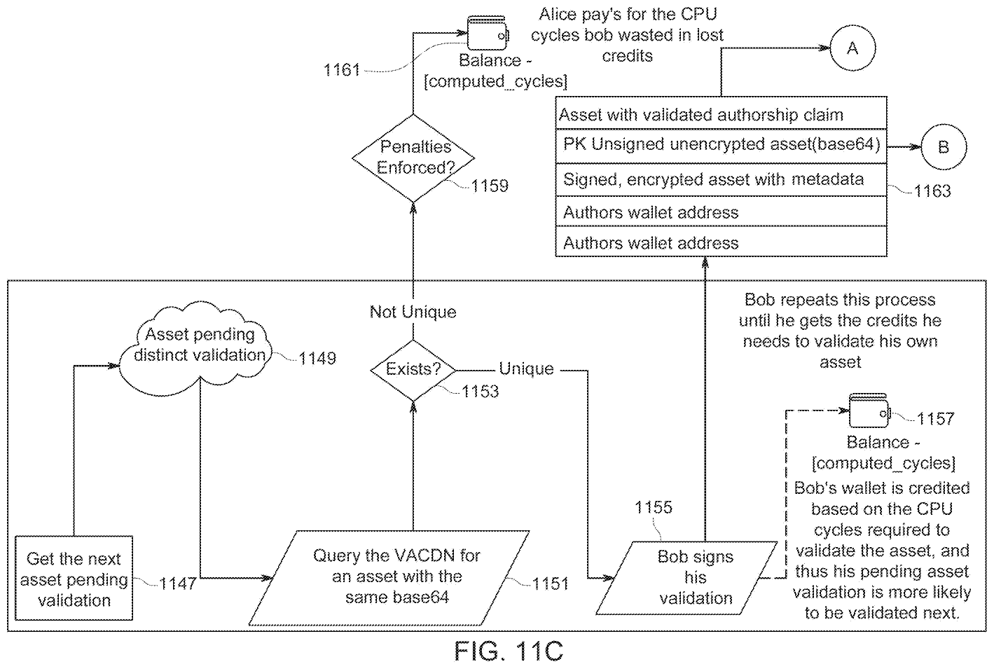

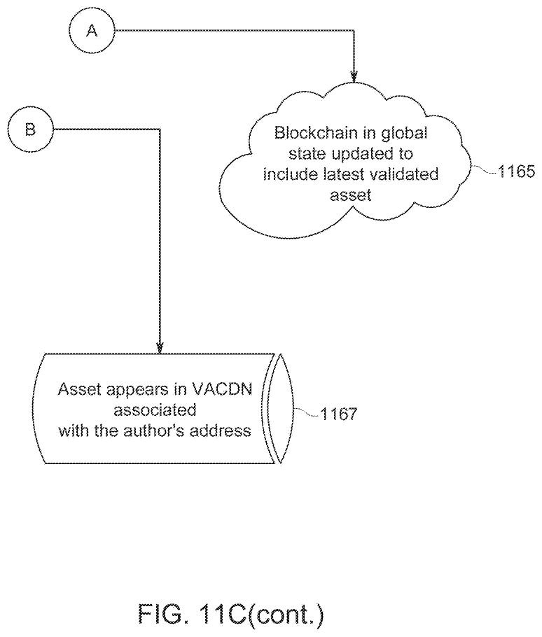

Thus, the consensus mechanism is designed to make the “51% attack” unfeasible and avoid repeated transactions. Exemplary usage of the consensus mechanism is described below with reference to FIGS. 11A, 11B, and 11C.

Referring to FIG. 11A, a workflow 1100a for claiming authorship of a digital asset by a first user is shown. Let the first user be named Alice. At step 1101, the digital asset may be selected by Alice. At step 1103, Alice may claim ownership of the digital asset. Accordingly, the digital asset and the ownership claim for the digital asset may be sent to the automatic digital asset authenticator 101. Thus, the digital asset at step 1103 is unsigned and unencrypted. At step 1105, the unsigned and the unencrypted digital asset may be encoded using the base64 encoding scheme. At step 1107, a “cost” of CPU cycles may be computed to validate based on size of the digital asset whose ownership Alice wants to claim and known public key. At step 1109, based on inputs from Alice, it may be determined whether Alice is okay with the cost of CPU cycles. In case Alice is not okay with the cost, the workflow 1100a ends at step 1113. However, if Alice is okay with the cost, the workflow 1100a proceeds to step 1111. At step 1111, it may be determined whether there is sufficient credit (or CPU cycles) available with Alice by checking balance of computed cycles 1115. When sufficient credit is available, the workflow 1100a proceeds to step 1117. At step 1117, authorship claimed by Alice is signed with wallet address of digital wallet associated with Alice. Further, the digital asset with metadata is encrypted using base64 encoding scheme.

At step 1119, entire claim is encrypted with public key of the blockchain which results in a hash of fixed length. Further, the digital asset is sent for distinct validation. At step 1121, Alice waits for pending distinct validation, where the distinct validation may be approved or rejected.

Referring to FIG. 11B, a workflow 1100b for claiming authorship of the digital asset by a second user is shown. Let the second user be named Bob. At step 1123, the digital asset may be selected by Bob. At step 1125, Bob may claim ownership of the digital asset. Accordingly, the digital asset and the ownership claim for the digital asset may be sent to the automatic digital asset authenticator 101. Thus, the digital asset at step 1125 is unsigned and unencrypted. At step 1127, the unsigned and the unencrypted digital asset may be encoded using the base64 encoding scheme. At step 1129, a “cost” of CPU cycles may be computed to validate based on size of the digital asset whose ownership Bob wants to claim and known public key. At step 1131, based on inputs from Bob, it may be determined whether Bob is okay with the cost of CPU cycles. In case Bob is not okay with the cost, the workflow 1100b ends at step 1133. However, if Bob is okay with the cost, the workflow 1100b proceeds to step 1135. At step 1135, it may be determined whether there is sufficient credit (or CPU cycles) available with Bob by checking balance of computed cycles 1137. When sufficient credit is available, the workflow 1100b proceeds to step 1139. At step 1139, authorship claimed by Bob is signed with wallet address of digital wallet associated with Bob. Further, the digital asset with metadata is encrypted using base64 encoding scheme.

At step 1141, entire claim is encrypted with public key of the blockchain which results in a hash of fixed length. Further, the digital asset is sent for distinct validation. At step 1143, Bob waits for pending distinct validation, where the distinct validation may be approved or rejected. In some embodiments, pending distinct validation requests may be stored in a central repository.

Further, at step 1145, a first block comprising pending distinct validation of the digital asset claimed by Bob and a second block comprising pending distinct validation of the digital asset claimed by Bob are created. In this way, a plurality of blocks comprising pending distinct validations of the digital asset claimed by multiple users are generated periodically. The blocks are prioritized by number of credits in the digital wallet of the multiple users (in this case Alice and Bob) making the claim of ownership of the digital asset. The prioritization based on the number of credits in the digital wallets incentivizes other users to validate uniqueness of the digital asset claimed by the users (for example, Alice and Bob in this case).

Referring to FIG. 11C, a workflow 1100c for validating claimed authorship of the digital asset is shown. In FIG. 11C, Bob wants his authorship claim for the digital asset to be validated. The pending distinct validation may be provided by the automatic digital asset authenticator 101. Initially, at step 1147, pending distinct validation request for the digital asset may be obtained from a central repository 1149 storing all the pending distinct validation requests. Further, at step 1151, VACDN may be queried for a digital asset with the same base64 encoding of the digital asset claimed by Bob. At step 1153, it may be determined whether there exists any other digital asset with the base64 encoding same as that of the digital asset claimed by Bob. In case, there exists no other digital asset with the same base64 encoding, the digital asset claimed by Bob is unique. Thus, at step 1155 validation for the digital asset may be signed by Bob. Accordingly, at step 1157, digital wallet of Bob may be credited based on the CPU cycles required to validate the digital asset. Thus, Bob's pending asset validation is more likely to be validated next.

Further, at step 1163, the digital asset with validated authorship claim is signed with wallet address of author (in this case Bob). Further, the digital asset with validated authorship claim comprises signature of validator (in this case Bob) and encrypted digital asset with metadata. At step 1165, blockchain global state may be updated to include latest validated digital asset. At step 1167, the digital asset may appear in VACDN associated with the wallet address of the author (i.e., Bob).

However, if there exists another digital asset with the same base64 encoding the workflow 1100c proceeds to step 1159. At step 1159, penalties are enforced. Accordingly, at step 1161, Alice pays for the CPU cycles Bob waste in lost credits. Above steps may be repeated until Bob gets the credits needed to validate his own digital asset.

In further embodiments, technology such as homomorphic encryption may be included to allow for detection of deepfake material claiming to be of internal/confidential status generated by the owner of a digital wallet. In one example, if someone posts what they claim to be a capture of a companies' quarterly earnings review meeting, or a company town-hall for employees. The supposed owner wishes to dispute the validity of the material, but doesn't want to disclose recordings of all possibly relevant events. In this scenario, the faked content could be compared to the full wallet, including both publicly visible and encrypted internal/confidential assets to find full or partial matches, without having to disclose the internal/confidential material. Homomorphic encryption may allow companies to store encrypted confidential content on the public blockchain, and allow consumers to detect deepfakes of media that are masquerading as leaked internal company materials, without the company having to disclose the confidential content the deepfake was based upon. Homomorphic encryption is a form of encryption with an additional evaluation capability for computing over encrypted data without access to the secret key. The result of such a computation remains encrypted. Homomorphic encryption can be viewed as an extension of either symmetric-key or public-key cryptography. Homomorphic refers to homomorphism in algebra: the encryption and decryption functions can be thought of as homomorphisms between plaintext and ciphertext spaces. Homomorphic encryption includes multiple types of encryption schemes that can perform different classes of computations over encrypted data. The computations are represented as either Boolean or arithmetic circuits. The types of homomorphic encryption disclosed as a part of some embodiments of the disclosed invention include partially homomorphic encryption, which can encompass schemes that support the evaluation of circuits consisting of only one type of gate, e.g., addition or multiplication, somewhat homomorphic encryption, which can encompass schemes that evaluate two types of gates, but only for a subset of circuits, leveled fully homomorphic encryption, which can encompass schemes that support the evaluation of arbitrary circuits composed of multiple types of gates of bounded (pre-determined) depth, and fully homomorphic encryption (FHE), which can encompass schemes that allow the evaluation of arbitrary circuits composed of multiple types of gates of unbounded depth, and is the strongest notion of homomorphic encryption.

Many modifications and other embodiments of the inventions set forth herein will come to mind to one skilled in the art to which these inventions pertain having the benefit of the teachings presented in the foregoing descriptions and the associated drawings. It is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

The invention illustratively disclosed herein suitably may explicitly be practiced in the absence of any element which is not specifically disclosed herein. While various embodiments of the present invention have been described in detail, it is apparent that various modifications and alterations of those embodiments will occur to and be readily apparent those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. The present disclosure also contemplates other embodiments “comprising,” “consisting of” and “consisting essentially of,” the embodiments or elements presented herein, whether explicitly set forth or not. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items, while only the terms “consisting of” and “consisting only of” are to be construed in the limitative sense.

Wherefore, I claim:

1. An automatic digital asset authenticator system comprising:
a processor coupled to a system bus;
a memory coupled to the system bus, the memory being a non-transitory machine-readable storage medium configured to store instructions for execution by the processor;
a communication interface coupled to the system bus; and
an automatic digital asset authenticator stored in the memory,
wherein the automatic digital asset authenticator is configured to cause the processor to automatically generate a non-fungible token (NFT) for a digital asset.

2. The system of claim 1 further comprising a digital wallet stored in the memory.

3. The system of claim 2 wherein the automatic digital asset authenticator includes an encoder, an encryptor, and an NFT generator.

4. The system of claim 3, wherein the automatic digital asset authenticator is configured to cause the processor to automatically divide a digital asset into a plurality of chunks and generate a separate, distinct NFT for each chunk.

5. The system of claim 4 wherein a length each chunk is between 0.10 seconds and 3 seconds length of video or audio time for video or audio digital assets.

6. The system of claim 5 wherein the encoder is configured to cause the processor to encode each chunk of the digital asset base64 strings.

7. The system of claim 6, wherein the NFT generator is configured to cause the processor to implement a secure hash algorithm to generate a unique signature for each chunk in real time as the digital asset is being inputted into the system.

8. The system of claim 7, wherein the encryptor is configured to cause the processor to encrypt the encoded digital asset.

9. The system of claim 8 wherein the encryptor includes a key generator and is configured to cause the processor to generate a private encryption key and a public encryption key using a hash of a seed phrase, wherein the seed phrase comprises a collection of characters in a language of the key generator.

10. The system of claim 9 wherein the automatic digital asset authenticator is configured to cause the processor to automatically generate a custom smart contract defining terms of creating the NFT and deploying the smart contract to a blockchain.

11. The system of claim 10 wherein the automatic digital asset authenticator is configured to cause the processor to store the private encryption key, the public encryption key, and NFT in the memory.

12. The system of claim 11, wherein the automatic digital asset authenticator is configured to cause the processor to sequentially create a first NFT for a first chunk of a digital asset, increment a nonce, and then continue creating additional NFTs for each additional chunk of the digital asset until an end of the digital asset is reached.

13. The system of claim 12 wherein the encryption is a homomorphic encryption.

14. A method for automatically authenticating digital assets using an automatic digital asset authenticator system including a processor coupled to a system bus, a memory coupled to the system bus, the memory being a non-transitory machine-readable storage medium configured to store instructions for execution by the processor, a communication interface coupled to the system bus, and an automatic digital asset authenticator stored in the memory, the method comprising:
loading a portion of a digital asset into the memory; and
the automatic digital asset authenticator being configured to cause the processor to automatically generate a non-fungible token (NFT) for the portion of the digital asset.

15. The method of claim 14 further comprising storing the NFT in a digital wallet stored in the memory.

16. The method of claim 15 wherein the automatic digital asset authenticator includes an encoder, an encryptor, and an NFT generator.

17. The method of claim 16 further comprising automatically dividing a digital asset into a plurality of chunks and generating a separate, distinct NFT for each chunk, with each chunk being between 0.10 seconds and 3 seconds length of video or audio time for video or audio digital assets.

18. The method of claim 17 further comprising encoding each chunk into base64 strings, and implementing a secure hash algorithm to generate a unique signature for each chunk in real time as the digital asset is being loaded into the system.

19. The method of claim 18 further comprising encrypting the encoded digital asset, generating a private encryption key and a public encryption key using a hash of a seed phrase, wherein the seed phrase comprises a collection of characters in a language of the key generator, and storing the private encryption key, the public encryption key, and NFT in the memory.

20. The method of claim 19 further comprising generating a custom smart contract defining terms of creating the NFT and deploying the smart contract to a blockchain.
